(19) United States
(12) Patent Application Publication
(10) Pub. No.: US 2021/0106480 A1
(43) Pub. Date: Apr. 15, 2021

(54) Apparatus for Securing a Patient on an Orthopedic Surgical Table Platform

(71) Applicant: Infinitus Medical Technologies LLC, Holly Springs, NC (US)

(72) Inventors: David J. Gomez, Holly Springs, NC (US); Nathan Winder, San Jose, CA (US)

(21) Appl. No.: 17/083,725

(22) Filed: Oct. 29, 2020

Related U.S. Application Data
(63) Continuation-in-part of application No. 16/899,796, filed on Jun. 12, 2020.
Application No. 16/899,796 is a division of application No. 15/437,017, filed on Feb. 20, 2017, now Pat. No. 10,709,626.
(60) Provisional application No. 63/075,276, filed on Sep. 7, 2020.
(60) Provisional application No. 62/927,177, filed on Oct. 29, 2019.
(60) Provisional application No. 62/296,863, filed on Feb. 18, 2016.
(60) Provisional application No. 62/409,578, filed on Oct. 18, 2016.

(51) Int. Cl. A61G 7/10; A61G 13/12

(52) U.S. Cl. CPC A61G 7/1023; A61G 7/1026; A61G 2210/90; A61G 13/1295; A61G 7/1073

(57) ABSTRACT

The present invention provides an apparatus for moving a patient on a pad and holding the pad in place on a an anterior hip table or a standard surgical table. The pad works in conjunction with the reusable patient lifting/moving base, allowing nurses to more readily and easily move patients on the table in order to facilitate surgical positioning. The pad may also be used in combination with a post overlay to prevent injuries to the genital area of the patient.

### CROSS-REFERENCE TO RELATED APPLICATION

The present application claims priority benefit of U.S. Provisional Patent Application No. 62/927,177 filed on Oct. 29, 2019, entitled “Apparatus for Securing a Patient on an Orthopedic Surgical Table Platform,” and U.S. Provisional Patent Application No. 63/075,276 filed on Sep. 7, 2020, entitled “Pneumatic Foam for Healthcare Use,” and is a continuation-in-part of U.S. patent application Ser. No. 16/899,796 filed on Jun. 12, 2020, entitled “Apparatus for Securing a Patient in the Trendelenburg Position During Surgery” which is a divisional of U.S. patent application Ser. No. 15/437,017 filed on Feb. 20, 2017, entitled “Apparatus for Securing a Patient in the Trendelenburg Position During Surgery” which claims priority benefit of U.S. Provisional Patent Application No. 62/296,863 filed on Feb. 18, 2016, entitled “Method and Apparatus for Securing a Patient in the Trendelenburg Position During Surgery” and U.S. Provisional Patent Application No. 62/409,578 filed on Oct. 18, 2016, entitled “Method and Apparatus for Securing a Patient in the Trendelenburg Position During Surgery,” all of which are hereby incorporated by reference.

### TECHNICAL FIELD

The present invention relates generally to the field of medical devices for use in the surgical theater, and more particularly to an apparatus for securing a patient on an orthopedic surgical table platform and a method of using such an apparatus to move patients more ergonomically to facilitate a surgical procedure.

### BACKGROUND ART

Current pad systems such as the “Pigazzi Pad” disclosed in U.S. Pat. No. 8,464,720 B1; the Ocean Breeze Pad by Prime Medical; and many other similar pads offered in the surgical market space; rely on either securing a viscoelastic pad via the bed rail system by means of hook and loop fastener based systems, or using the pad's viscoelastic surface along with the patient's weight to keep the pad from sliding. These systems are designed to keep the pad and the patient from sliding during surgical bed positioning changes, most commonly the Trendelenburg (head down) surgical position. This angled Trendelenburg position may range from 0 to 40 degrees. As with current viscoelastic pad systems, standard draw sheets (both woven and nonwoven materials) are then placed under the patient to either move the patient or to keep the patient's arms in place at the patient's side. It is important to note that these draw sheets can minimize full contact surface between the patient's back (skin) and the pad or gel surface increasing the risk or possibility for patient slippage or drifting in gravity dependent positions. This result is due to a reduction in contact between the viscoelastic pad and the patient's skin resulting in less friction or impression/residual compression needed to keep the patient in a static position. These risks are compounded with each increase in the angle of the Trendelenburg position.

One problem with existing pad or gel based systems is that once they are secured to bed rails, the existing systems are not easily moveable, especially when under the weight of the patient. They are fixed in their location once secured. This limits ease of movement of the patient to an optimal surgical position once the patient is settled into the pad system and secured. Due to the lack of easy and ergonomic movement of patients placed upon these fixed surfaces, providers are routinely forced to place the patient in a less than optimal position for anesthesia airway access needed for direct laryngoscopy, a necessary requirement for general anesthesia. Providers either place short patients more proximal to them for optimal airway access, or place patients farther down the table away from them, to minimize the repetitive lifting of patients under general anesthesia.

Because most pads are fixed and secured via hook and loop fastener straps, providers must physically and bodily lift the patient off of the semi adhesive pad/gel systems in order to move the patient into the correct bed position required for surgery. In the disclosure of the Pigazzi patent (U.S. Pat. No. 8,464,720 B1) this is performed via the “cloth-like” draw sheet, which is also used to facilitate arm adduction. The draw sheet included in many viscoelastic foam packs is made of a paper/cloth like material and often lacks full strength to facilitate movement of the patient by providers when positioning changes are required. The providers must routinely grab bodily portions of the patient's torso in contact with the pad in order to move the patient down. It is fairly common in practice to see the pad move or bundle under the patient as larger patients cannot be fully elevated off of the pad thereby dragging the pad with the patient. This foam or gel bundling can lead to pressure points that may lead to injury (e.g., pressure-related skin injuries).

Another issue with viscoelastic or memory foam is that the temperature at which a memory foam retains its properties is limited. If it is too cold, the memory foam will harden. If it is too hot, the memory foam will act like conventional foams, easily springing back to its original shape.

Routine movement and methodologies for moving patients on these pad/gel based systems begin to fail, especially during the care of moderate to morbidly obese patients. Rising obesity rates in the United States also place significant ergonomic safety and injury risks to health care providers as they must routinely physically lift and move these patients in order to facilitate certain surgical procedures. The healthcare industry faces a problem with a lack of products focused on improving methodologies and practices that facilitate less variance and safe care strategies, i.e., process improvements required for surgical positioning. The industry also lacks products designed to provide safer and more ergonomic processes for moving patients, which can be a key contributor to musculoskeletal disorders (MSD) and injuries (especially involving the back) suffered by providers.

Orthopedic surgical technologies are rapidly evolving in their pursuit to improve outcomes, while reducing time for convalescence and rehabilitation through the use of less invasive surgical implant techniques. Over the last decade there has been a huge shift from traditional lateral hip implant insertions to anterior hip insertion of implants.

One significant change in the industry has been through the advent of advanced orthopedic surgical table platforms designed specifically for anterior hip surgical access. This includes total hip arthroplasties, hip arthroscopies, and other open reduction internal fixation techniques. This also includes platforms designed to improve pelvic orthopedic traumas. There are many manufactures of these highly specialized surgical tables, but one of the most prevalent in the United States is the HANA table available from Mizuho OSI of Union City, Calif.

Most hip tables require the use of a center post. This post is designed to secure and stabilize the patient's pelvis and to serve as a fulcrum when the legs are pulled (and/or slightly rotated) in order to disarticulate the joint space needed. This fulcrum distraction force is measured in either pounds or Newtons. This often foam or gel padded post also serves as a lateral stabilizing force, especially on narrow angles surgical table platforms like the Mizuho OSI® HANA® table, as well as other distal angled manufactured tables.

There has recently begun a trend toward not using this post as a primary pelvic traction anchor due to the high potential for perineal or genital tissue pressure injuries, as well as injuries to surrounding tendons, muscles, and nerves, especially the pudendal nerve.

As the legs are pulled, the patient's weight is centered on the round post, increasing the risk for pressure injury. This creates a “straddle” type pressure model of force, despite the extra padding placed. Despite the use of padding, human tissue pressure greater than 30 mmHg (or 0.6 lbs of force) can decrease capillary blood, thus increasing the risk of tissue, nerve, and vascular ischemia.

Having a post may be desirable from a patient safety perspective, as the table is narrow and angled distally to allow for surgical access needed for joint insertion and fluoroscopy (X-ray) needed to guide implant selection and placement. Accordingly, there is a need for an improved system to be used with a post.

Most existing foam technologies currently used for gravity dependent stability or force pulled distraction are made up of 1-3 inches of foam with straps sewn or glued into the foam substrate. This creates laxity within the material when under the sheer stress of gravity or during extremity distraction. This can impact stability on the table, and perioperative fluoroscopy (X-ray) as the patient's movement from tearing or elongation, of even just a few inches, impact time and efficacy of fluoroscopy (X-ray). What is needed is a pad assembly that will provide the friction needed to stabilize patient's during joint distraction, with or without the post (at low distraction force pound or Newtons), while maintaining the utility of movement needed to facilitate both general and regional anesthesia techniques for anesthesia and surgical staff.

### BRIEF SUMMARY OF THE INVENTION

The present invention meets the above described need by providing a device that allows the post to be placed during loading, surgical preparation, and surgical de-draping prior to movement to post-operative stretcher or bed. It may also be used on certain patient populations if the patient were extremely thin or large. The design of the foam overlay on the post is designed to achieve the level of stability needed, while reducing the “straddle” pressure needed to minimize inertia of force against the round post during distraction.

The apparatus of the present invention improves and optimizes clinical efficacy, time, staff utilization, and safety for both patients and staff. The pad system facilitates standardization of care by creating less variance during use, while serving to improve safety for providers during ergonomic weight bearing physical movements routinely required during surgical positioning.

The apparatus of the present invention provides a standard approach to moving patients during routine and well known surgical procedures requiring positioning changes while securing the patient by means of a unique material reinforced foam pad using a non-residue pressure sensitive adhesive (“PSA”) system.

The apparatus of the present invention reduces or eliminates the need to pick the patient off of a viscoelastic/gel-based pad via either the “draw sheet” or awkward manual bodily lifting methodologies conducted by the staff.

Instead, the apparatus of the present invention provides a fully moveable system that moves both pad and patient and even helps transfer the patient to a post-operative stretcher, which also aids ergonomic processes inherent in surgical care.

The present invention incorporates a handled lift and slide utility to serve as an extended utility to this platform. The antiskid (or friction) Pneumatic (PNEUMAFOM®) foam top provides the necessary resistance and friction required when pulling to dislocate the hip joint. The foam top also provides traction and stability when moderate tilting of the table or Trendelenburg (head down) is used to improve distraction.

It is always a necessary requirement to lift and move anesthetized (spinal, epidural, or general anesthesia) patients from the patient stretcher after insertion of regional anesthesia, or after the induction of general anesthesia, to the orthopedic table. It is also required to move the patient, if applicable based on the surgical table's design, up to 1-2 feet to the distal end of the table to facilitate the procedure. This movement is usually performed by staff lifting a patient by hand and sheet. This procedure is why the ability to move both patient and friction pad are important. It serves to improve staff ergonomics, facilitate anesthesia technique (general, regional, or combined), and to stabilize the hip or fracture, as it reduces the traditional patient handling methodologies require to roll and turn patients in order to move them.

While there may be hover assist devices to move patients from lateral to lateral surfaces, they were not designed to withstand gravity dependent forces, as the structural fabric against the mattress top is a low friction surface. They are also oversized and most of these tables are consolidated in their design to facilitate exposure to the hip. None of them are meant to be kept under patients undergoing gravity dependent rotations of the surgical table, or during forced distraction of the hip by pulling one portion of the lower body, while the main part of the patient's body (torso) is secured via friction or a perineal post. This reality increases the risk of sliding in gravity dependent bed changes or when the body is pulled a contralateral direction. These tables are usually very narrow, and any oversized movement assist device would get in the way of various accessories required for surgical access and manipulation.

The handled lift pad utility of the present invention helps improve the ergonomic patient handling and positioning of patients over the standard and historic use of moving patients by hand and lift sheet, especially when caring for obese patients, or those patients with hip fractures. The current embodiment can be placed under the patient when regional anesthesia (spinal, epidural, and combined) is used on the patient stretcher, thus allowing safer ergonomic transfer of patients to the table after regional, sedation, or general anesthesia is performed, as patients cannot be placed on these narrow tables before these anesthesia processes due to the table size, or when the tables accessories are not utilized correctly.

The supportive non-woven structure of the pad assembly of the present invention allows for the device to be anchored onto the table via two methods, a set of bilateral straps at the upper end of the pad are secured to the surgical bedrail and either the distal end of the table's rail structure, or around the narrow angle of specialty tables. The lower end of the pad may also be anchored via an optional post insertion placed proximal the structure of the foam pad lift system distal end. A tear away foam structure may accommodate this post insertion.

The reinforced foam pad design of the present invention and structure provides a stronger and more reinforced fixed anchor to the table, than a foam pad alone. This allows greater degrees of force stabilization needed for disarticulation and gravity dependent forces that would normally stretch/elongate, or tear the pad.

The accessory post design of the present invention also has a unique foam design utility, one that provides greater resistance, when combined to the opposing friction force of the PNEUMAFOM® top, during distraction when forces of greater than 150 lbs of force are used. This provides additional resistance and sheer needed to maintain traction against the perineal post that serves to minimize tissue injury secondary to sheering and sliding against the fixed post imbedded into foam material overlay. The unique non rounded radius of the post overlay accommodates male and female genitals to reduce pressure into a normally rounded surface area (straddling).

The foam pad is made of polyurethane or other types of fast recovery or compressible foam needed to provide some degree of traction and support. The most predominant of these is non “memory foam” or “viscoelastic” in origin or ingredients. The density is set to provide adequate cushioning needed to reduce pressure injuries, as most current viscoelastic foams “bottom out” when subjected to heavy patient and bony skeletal structures such as the scapula and sacrum, as they are only 1-3 inches on average. The foam is temperature stable and not subject to the “glass transition” or hardening viscosity due to cold operating room environments. It does not impede grounding during cautery and is readily radiolucent.

The post overlay design fits over the standard perineal post on any anterior hip table in the industry. It may be made for posts with an external diameter of 2-6 inches. The design is unique to the procedure use and utility of the post.

The foam overlay fits over and secures the distal end of the pad and table to stabilize the patient. The post also provides a fulcrum of stability and resistance during hip joint distractions of 80-300 lbs. of force, as the legs are manually or mechanically pulled via the table's leg accessory traction devices. These posts are typically round.

When the legs are pulled, two forces happen. Once force moves the patient into the post. This is where post stability provides a mechanical fulcrum needed to distract the hip joint. Then the leg is pulled, the other leg is usually fixed it to place, but in some systems this may not provide enough retraction to overcome the contralateral shifting of weight or the patient to towards the side being pulled. This can impact X-ray and fluoroscopy needed to identify the distraction. In essence, instability creates a moving target of a few inches. This can force movement of X-ray repetitively during the procedure.

The underlying pneumatic (PNEUMAFOM®) friction pad will also greatly reduce the amount of overall force and inertia into the underlying post.

The lower edge of the post overlay is elongated to restrict the patient's movement at the surface of the pad. As it rises, it further restricts forward movement into the post. The concave cuts are designed to accommodate and restrict the amount of force against the patient's perineal and genital tissue. Typical round post foam pads do not make space for the genitals.

### BRIEF DESCRIPTION OF THE DRAWINGS

FIG. 1 is a perspective view of an orthopedic surgical table platform designed specifically for anterior hip surgical access.

FIG. 2 is a perspective view of a pad assembly disposed on the upper surface of an orthopedic surgical table platform.

FIG. 3 is a perspective view of a pad assembly and a post overlay on a standard surgical table.

FIG. 4 is a top perspective view of a post overlay of the present invention.

FIG. 5 is a perspective view of the post overlay of FIG. 4.

FIG. 6 is a top perspective view of the post overlay of FIG. 4.

FIG. 7 is a side elevational view of the post overlay of FIG. 4.

FIG. 8 is a rear elevational view of the post overlay of FIG. 4.

FIG. 9 is an exploded perspective view of the pad assembly of the present invention.

FIG. 10 is a top perspective view of a first embodiment of the pad assembly.

FIG. 11 is a bottom perspective view of the embodiment shown in FIG. 10.

FIG. 12 is a top plan view of the base prior to mounting the foam top.

FIG. 13 is a bottom plan view of an alternate embodiment of the base.

FIG. 14 is a top plan view of an alternate embodiment of the base prior to mounting the foam top.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

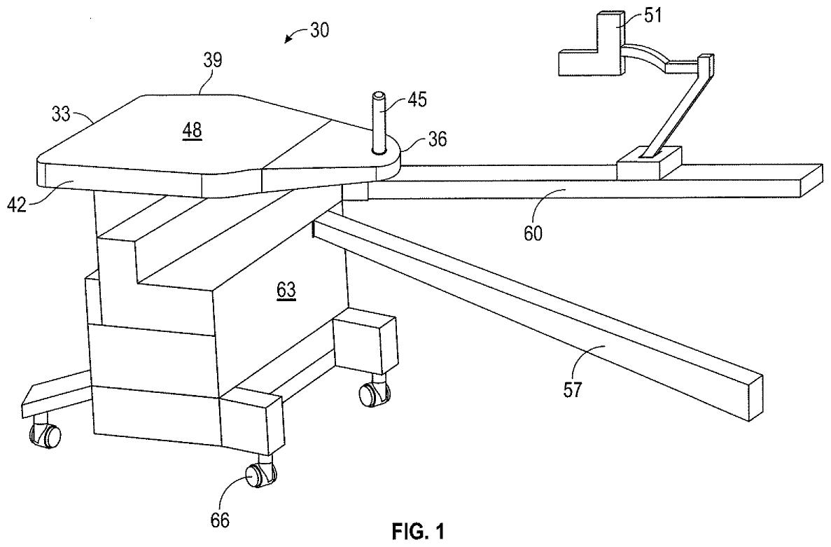

Referring to FIGS. 1-18 generally, and initially to FIG. 1, an orthopedic surgical table platform 30 such as the HANA brand table available from Mizuho OSI of Union City, Calif., has a first end 33 and a second end 36 disposed opposite from the first end 33. The platform 30 is wider at the first end 33 and gradually narrows inward from opposed sides 39, 42 until it reaches the second end 36. A cylindrical post 45 may be disposed in spaced apart relation from the second end 36. The post 45 may extend for a relatively short distance above a top surface 48 of the surgical table platform. The top surface 48 may be planar as shown. In use, a patient may be supported on the top surface 48 such that the torso extends downward and each leg of the patient may be disposed on opposite sides of the post 45. The legs of the patient may extend to foot support 51 that may be supported by elongate members 57 and 60 extending from the base 63. A foot support 51 may be adjustably mounted on both elongate members 57, 60 as shown in connection with member 60 in the drawing. The base 63 supports the elongate members 57 and 60 and provides for adjustment of the elongate members 57, 60 in multiple planes. The base 63 also supports the platform 30 and top surface 48. The base 63 may also be provided with casters 66.

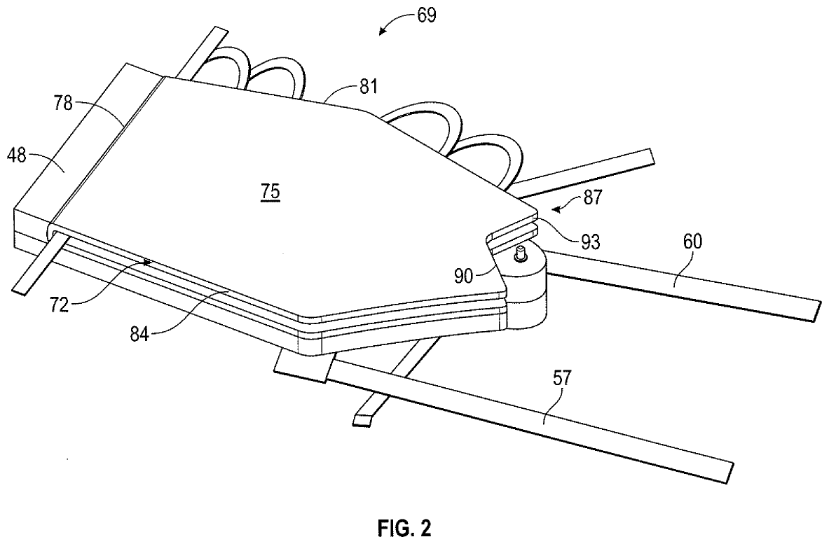

Turning to FIG. 2, a pad assembly 69 of the present invention may be supported on the top surface 48. The pad assembly 69 has a foam top 72 with a planar surface 75 that supports a patient undergoing a procedure on the platform 30. As shown the foam top 72 has a shape that conforms to the shape of the top surface 48 with a bottom portion 78, opposed side portions 8l, 84, and a top portion 87. The top portion 87 is formed by two inward angled sections 90 and 93 that provide for a truncated top portion 87 that provides room for the post 45 (FIG. 1). The pad assembly 69 is described in greater detail herein.

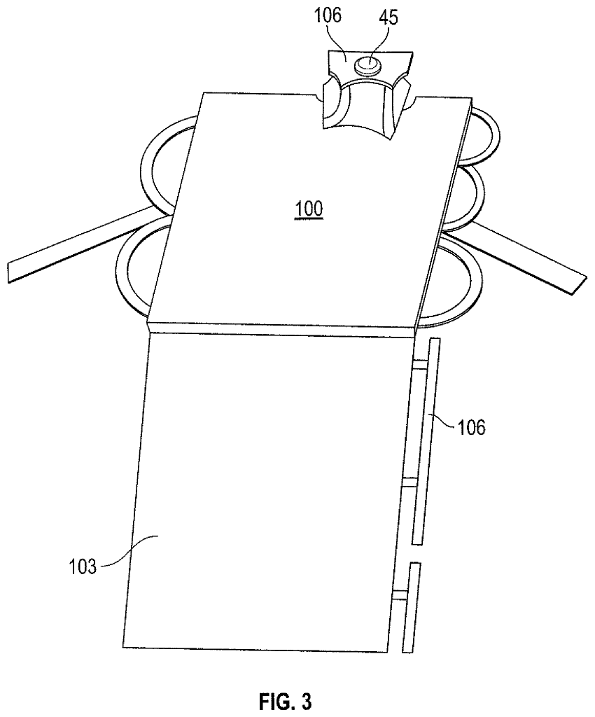

In FIG. 3, an alternate embodiment of the pad assembly 69 is shown. Pad assembly 100 may be mounted on a standard rectangular shaped surgical table 103. A standard bed rail 106 extends from the side of the table 103. A post 45 and post overlay 106 are shown at one end of the table 103. The components of the pad assembly 100 and post overlay 106 are described in greater detail herein.

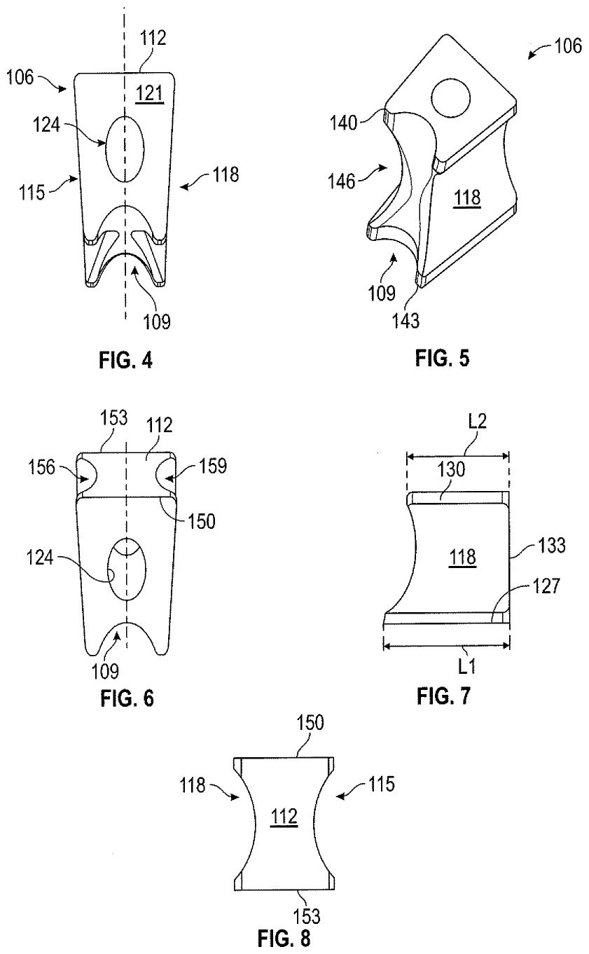

Turning to FIG. 4, the post overlay 106 may be constructed of a resilient, flexible material that provides cushioning to prevent injuries when the body of the patient contacts the post 45 during a medical procedure. The foam may comprise a polyurethane foam having 1.8-6 lb density with a 24-45 ILD (indentation load deflection) range. Other flexible foam materials may also be suitable. The post overlay 106 has a front wall 109, a rear wall 112, and opposed side walls 115, 118. The post overlay 106 has a central body portion 121 with an opening 124 defined therein. The opening 124 has an inside diameter sized to mate with the outside diameter of the post 45. Other shapes for the opening 124 and the post 45 may also be suitable as will be evident to those of ordinary skill in the art based on this disclosure.

In FIG. 5, the side wall 118 is concave. The side wall 115 on the side opposite from side wall 118 is also concave. The front wall 109 is also concave. The front wall 109 is widest as the top 140 and the bottom 143 and is narrower in a mid-portion 146. Accordingly, the front wall 109 has an “hourglass” shape with inward curves at the top and bottom and in the middle.

Turning to FIG. 6, the rear wall 112 may be substantially flat and is straight at the top edge 150 and bottom edge 153. The sides 156, 159 of the rear wall 112 are curved inward. The opening 124 for the post 45 extends from the top surface through the entire height of the post overlay 106. The front wall 109 is concave.

In FIG. 7, the side wall 118 is shown in greater detail. At the bottom edge 127, the side wall 118 has a length L1 that is greater than the length L2 of the top edge 130. The rear 133 of the side wall 118 is substantially vertical and is oriented at approximately ninety degrees with respect to the top and bottom edges 130, 127 of the side wall 118. The front of the side wall 118 curves from the bottom edge 127 to the top edge 130.

In FIG. 8, the rear wall 112 is best shown. The side walls 115, 118 curve inward from the top edges to the bottom edges along an arc.

The design of the post overlay 106 provides space to accommodate the genital area thereby reducing the overall pressure into the post 45 as it relates to genital tissue. The lateral concave surfaces of the side walls 115, 118 accommodate the legs when adducted, or during any crossover movements required to help with joint distraction. The ILD and makeup of the foam pad 72 provides the necessary force deflection to minimize tissue pressure while absorbing inertial forces into foam instead of the post 45 in contrast to typical round overlays. When combined with the underlying movable friction foam pad option, the overall inertia into the post 45 is greatly reduced over standard reliance on either post overlay or foam pad alone.

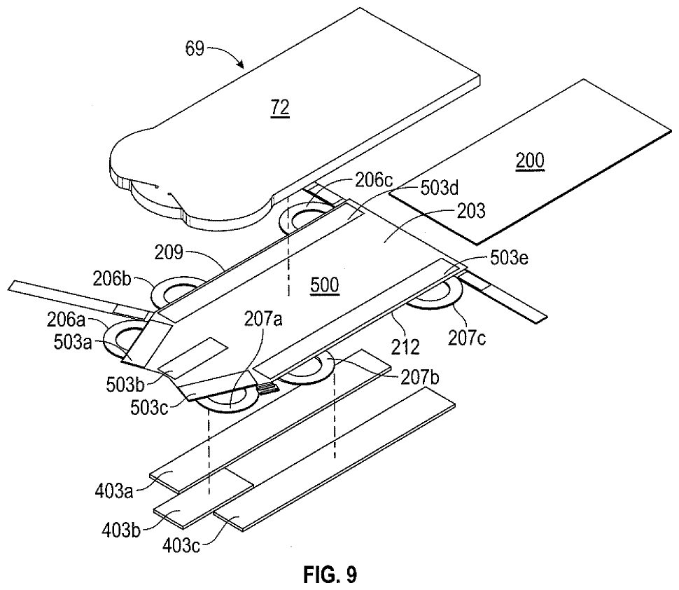

Referring to FIG. 9, the pad assembly 69 of the present invention is shown in an exploded view. The pad assembly 69 may comprise three main components including the foam top 72, a reinforcing substrate sheet 200, and a base 203.

The foam top 72 provides a support surface for the patient. The foam top 72 may be constructed of a polyurethane foam referred to as a pneumatic foam. A fast recovery, compressible and resilient foam is used to provide a high degree of traction and support at distraction pressures of 5-300 lbs of force pulled via manual or mechanical pulling of the lower extremities. Pneumatic foam having an optimized ILD (indentation load deflection) to restrict “bottoming out” provides resilient rebound needed to protect skin and tissue integrity in cold operating room environments is provided. Most viscoelastic memory foams collapse greater than or equal to 70-98% due to their ILD when patient weight is added, and provide slow rebound due to changes in foam viscosity in cold operating room environments. The foam top 72 of the present invention may comprise a pneumatic foam that is a foam that remains flexible at low temperatures in contrast to memory foam. The foam remains flexible at low temperatures because of its conventional foam chemistry (non-viscoelastic). The foam improves pressure reduction in cooler environments like the operating room and can function without efficacy loss across a temperature gradient of 0 to 100 degrees F. The foam may comprise a polyurethane foam with the following ingredients: polyether, polyol MDI, water, silicone, surfactant, amine, catalyst blue and pigment. The pneumatic foam is a polyurethane foam available by product number HRJZ12250BUM from Rogers Foam Corporation in Somerville, Mass. The foam may have a density of 2.35-2.65 pounds per cubic foot (PCF). The foam has 25% IFD (15×15×9) of 12-17. Additional properties include: Tensile psl=6 (min.); Elongation %=120 (min); Tear, ppi=0.5 (min); Comfort factor=1.6 (min); Hysteresis %=25 (max); and ball rebound 20-25%.

The base 203 may be made of a sturdy, flexible material. The material may be a nonwoven layered material such as SMS (spun-melt-spun), similar celluloid material, or the like. The base 203 is also provided with a plurality of handles 206a, 206b, 206c, and 207a, 207b, and 207c extending outward from the sides 209, 212 of the base 203. The handles 206a-c and 207a-c may be formed by loops of material attached to the sides 209, 212 of the base 203. The handles 206a-c and 207a-c are sized to receive the hand of a provider such that a provider on each side of the device can grasp the handles 206a-c or the handles 207a-c with their hands in order to move the base 203 along the length of the surgical table to position and re-position the patient as necessary during a surgical procedure. Alternatively, two providers on each side can each grab a handle 206a-c or 207a-c to move heavier patients.

The reinforcing substrate sheet 200 provides additional structural support for the pad assembly 69. The reinforcing substrate sheet 200 may be constructed of a condensed foam or biodegradable cardboard piece that may be inserted between layers of the nonwoven material that comprise the base 203.

The foam top 72 may be attached to the base 203 by pressure sensitive adhesive or spray adhesives or any other attachment method as will be evident to those of ordinary skill in the art based on this disclosure. A high friction polyurethane or pneumatic foam top 72 is joined to the nonwoven base via spray adhesive or pressure sensitive adhesive. All of the adhesives are FDA approved.

The pad assembly 69 with a pneumatic foam top 72 is preferable to foam by itself because the extra support provided by the combination of the base 203 and the foam top 72 prevents the foam from bunching up under the patient when lifting and/or repositioning the patient. It also allows the provider to pull back in case the patient was not positioned correctly. The pad assembly 69 provides structure so that the foam does not elongate, tear, or create laxity during distraction forces required to expose the joint.

The pad assembly 69 may be assembled and mounted by means of PSA strips 503a-503e and 403a-403c as described in greater detail herein.

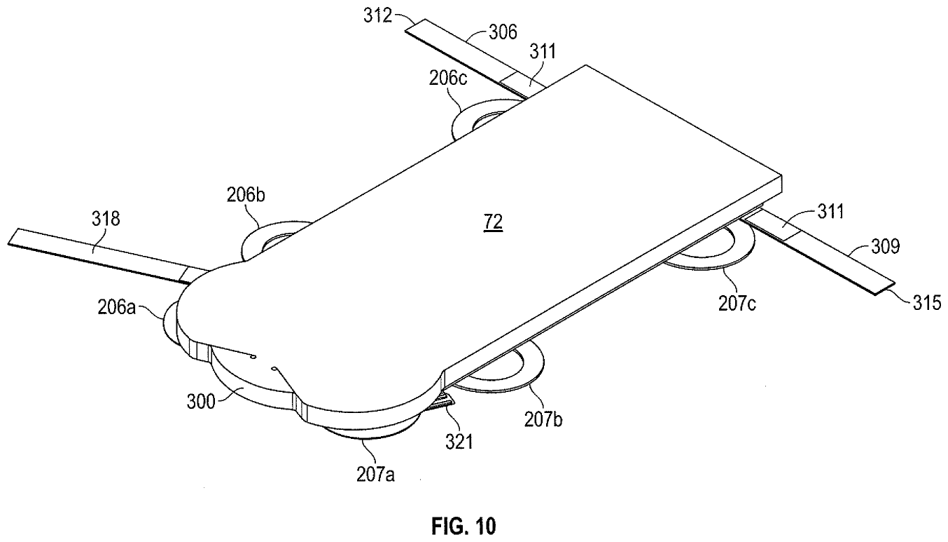

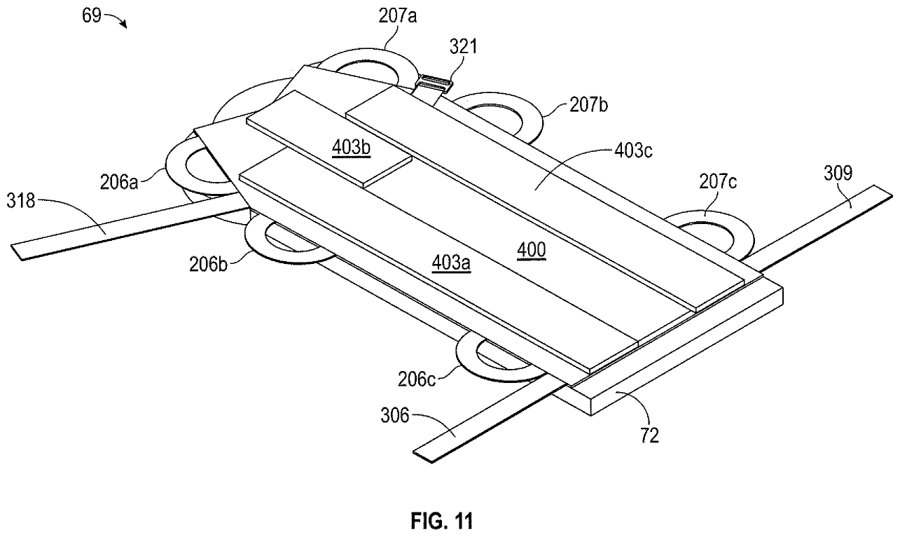

Turning to FIG. 10, pad assembly 69 has a foam top 72 that has a front section with a frangible portion 300 that can be removed to accommodate a post 45. The pad assembly 69 may also be used on a table without a post 45. A pair of straps 306 and 309 extend in opposite directions from the rear of the assembly 69. The straps 306 and 309 may be provided with mating hook and loop fastening surfaces 311 such that the distal end 312, 315 of the straps 306, 309 can be inserted through a bed rail and then secured to the mating hook and loop fastening surface 311. For a narrow table design specific to hip procedures, the front of the pad assembly 69 may be provided with a strap 318 extending from one side and a buckle 321 extending from the opposite side. At the narrower portion of the table the strap 318 can extend across the underside of the table and engage with the buckle 321 to secure the pad assembly 69 to the platform 30.

Turning to FIG. 11, a bottom surface 400 of the pad assembly 69 may be provided with a plurality of strips of pressure sensitive adhesive (“PSA”) 403a, 403b, and 403c. The PSA strips 403a-c are configured to engage with the top surface 48 (FIG. 1) of the platform 30. The PSA is FDA approved, and provides for temporarily securing the pad assembly 69 at different locations on the top surface 48 of the platform 30.

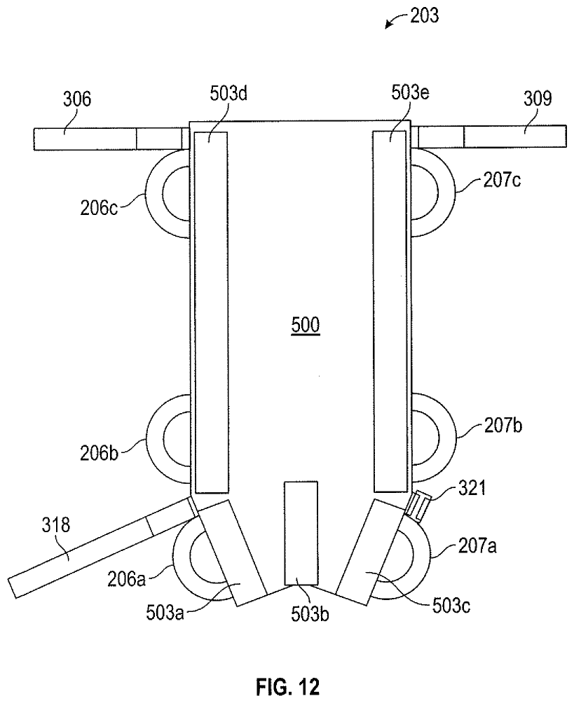

In FIG. 12, the base 203 is shown in greater detail. A top surface 500 of the base 203 provides a mating surface for mounting the foam top 72. As shown, the foam top 72 may be attached, secured or fused to the base 203 by means of pressure sensitive strips 503a, 503b, 503c, 503d and 503e. Other means for attaching the foam top 72 to the base 203 such as by sewing, fusing, adhesives or the like may also be used as will be evident to those of ordinary skill in the art based on this disclosure.

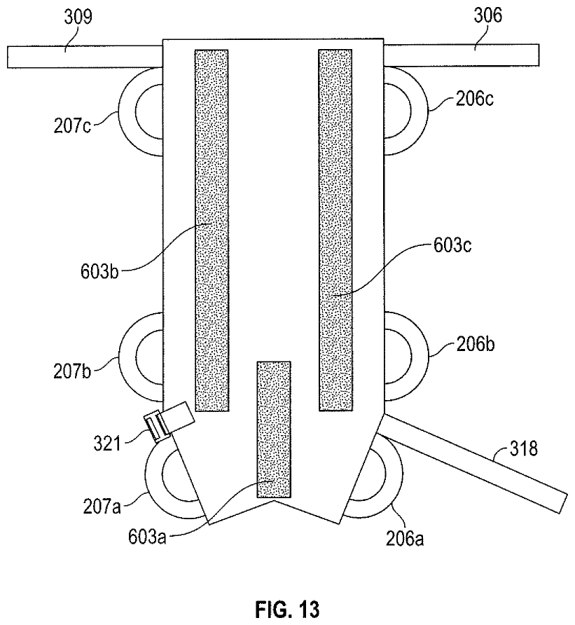

Turning to FIG. 13, a bottom surface 600 of the pad assembly 69 may be provided with a plurality of areas of spray adhesive 603a, 603b, and 603c. The areas of spray adhesive 603a-c are configured to engage with the top surface 48 (FIG. 1) of the platform 30. The spray adhesive is FDA approved, and provides for temporarily securing the pad assembly 69 at different locations on the top surface 48 of the platform 30.

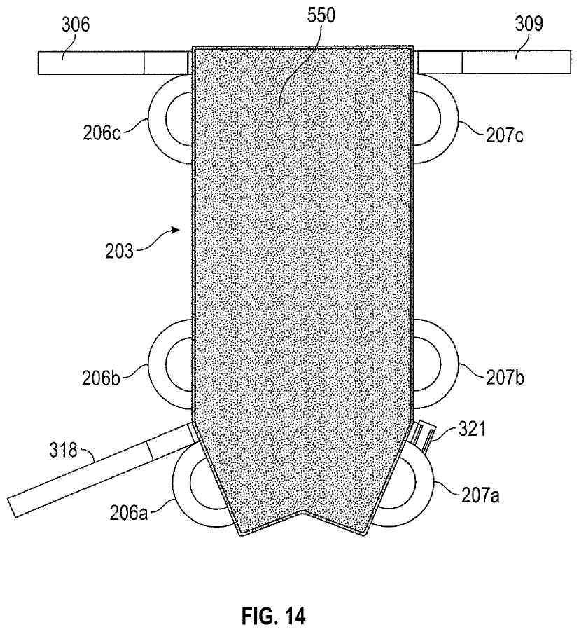

In FIG. 14, another process for attaching the foam top 72 to the base 203 may include use of a spray adhesive. The spray adhesive 550 may be applied across the entire area of the top surface 500. After the spray adhesive is applied, the foam top 72 may be secured to the base 203 on the top surface 500 by means of the adhesive.

The present invention provides many advantages. The present invention provides surgical providers with a pad assembly 69 to be placed under a patient (before or after) performing routine processes such as regional anesthesia (spinal, epidural, or combined/CSE), in either a sitting or lateral position, or (before or after) general anesthesia induction and intubation processes while on the patient's bed or stretcher. The movable friction pad assembly 69 allows staff to safely move a patient onto a narrow anterior hip table with better ergonomics over traditional sheet and hand lifting. The foam pad also allows staff to move both patient and pad distal to the apex of the table for surgery. Next, they strap and secure the patient, placing an optional post pad overlay and post between the patient's legs to lock the system down for security and stability for both lateral and distraction stability.

The present invention provides a modular friction pad assembly made of pneumatic foam that is resilient and provides rebound support required for optimized tissue management. Pneumatic foam is not a “memory foam” and does rely on the indention of patient weight to hold and secure the patient during distraction. It relies on its high friction coefficient to maintain traction and support needed for stability. The foam is not affected to temperature via the “glass transition” typical of memory foams. It does not require the patient's warmth or direct contact to provide pressure support or relief, especially in colder operating room environments. Pneumatic foam does not change viscosity based on temperatures in ranges from 0 degrees Fahrenheit to 100 degrees Fahrenheit. The foam maybe designed to overlay distal handles located bilaterally at the hip needed to assist safe ergonomic movement of patients during hip surgeries on narrow surgical tables, while protecting the integrity of the hip during movements to reduce tissue injury of lacerations that could potentially impact tissue integrity and infection.

The present invention also provides a modular friction pad assembly with handles that allows patients to be moved post operatively onto a stretcher or inpatient bed, thereby improving the comfort of patient over moving the patient on a “hard” rolling board. This creates a seamless transition and “log-roll” stability needed for post-operative joint stabilization.

The present invention also provides a modular pneumatic foam friction pad with handles that has a fast recovery of compressible and resilient foam needed to provide a high degree of traction and support at distraction pressures of 5-300 lbs of force pulled via manual or mechanical pulling of the lower extremities. Pneumatic foam has an optimized ILD (indentation load deflection) to restrict “bottoming out”, thus providing resilient rebound needed to protect skin and tissue integrity in cold operating room environments, as most viscoelastic memory foams collapse >70-98% due to their ILD when patient weight is added, and provide slow rebound due to changes in foam viscosity in cold operating room environments.

The present invention provides a modular reinforced pneumatic foam pad assembly with handles that has a high friction coefficient needed to hold patients in place during hip distraction for both hip arthroplasties and arthroscopies.

The present invention provides a modular reinforced friction pad assembly with non-woven SMS or similar material structure fused to the friction foam pad so the pad does not elongate, tear, or create laxity during distraction forces required to expose the joint. High friction polyurethane or pneumatic foam top may be fused to the “handled” non-woven base via spray adhesive or high quality pressure sensitive adhesive, each made of FDA approved adhesives.

The present invention provides a modular reinforced friction pad assembly that does not require a draw or lift sheet to move or transfer a patient, thereby maximizing pad to skin contact needed for maximum traction and stability. Draw sheets create heavy and poor ergonomic lifting burdens for surgical staff, as they must physically lift patients off high friction surfaces in order to move them effectively. This places providers at risk for ergonomic MSD injuries. The sheet also reduces effective pad to skin contact needed to optimize friction between the patient and the pad.

The present invention provides a modular friction pad assembly that may be paired with an optional post overlay designed to restrict movement incrementally from pad to skin surface of the lower buttocks, while accommodating genital anatomic structures via a concave and non-rounded design that is gradually accentuated from top to bottom. This post overlay design reduces the overall force and inertia into the underlying post and accounts for genital, vascular, and nerve anatomy, and the special physics involved during hip joint distraction via manual or mechanical pulling of the legs.

The present invention provides an optional post overlay design that is concave and slanted from top down towards patient's perineum needed to restrict mechanical and tissue force into the genitals, underlying nerves, and surrounding tissue.

The present invention provides an optional post overlay with lateral concave design needed to support the legs during crossover distraction methods, thereby minimizing force into the underlying post from a lateral perspective against the thighs. The foam is a polyurethane foam of 1.8 lb-6 lb density with 24-45 ILD range. The post overlay may be paired with a modular friction pad assembly.

The present invention provides an optional post overlay that when combined with a modular foam friction pad assembly, reduces the overall forces into a perineal post by more than either the overlay or pad assembly alone, especially when using distraction pressures higher than 150 lbs. of force, or when pulling lower extremities (distraction) on thin adults that may have more contralateral movements during distraction due to their weight and center of gravity changes. The combined lateral stability of the pad assembly and overlay may also reduce falls in high BMI patients on narrow angled hip tables in comparison to either product alone.

The pad assembly of the present invention provides some friction resistance needed to disarticulate the joint and to reduce the amount of “straddling pressure” into a round post. If the post is still required to be used, the resistance decreases the amount of bodily inertia against the post, as the rest of the body's skin to friction contact on the underlying material holds traction and resists distal movement, thus minimizing perineal force movement into the post as the feet and legs are pulled.

The present invention may provide a hybrid approach to include a post. As it may be unclear how much force is required for disarticulation, and the fact that there is no standard agreed or accepted amount of force in the industry, the post may serve as a minimal fulcrum force for distraction, or more importantly lateral stabilization.

Therefore, while the presently-preferred form of the apparatus for positioning a patient on a surgical table has been shown and described, and several modifications and alternatives discussed, persons skilled in this art will readily appreciate that various additional changes and modifications may be made without departing from the spirit of the invention, as defined and differentiated by the following claims.

1. An apparatus for positioning a patient on a surgical table, the apparatus comprising:
a base having a top surface, the base having a plurality of handles attached thereto;
a foam top fixedly mounted to the top surface of the base to form a pad assembly, the foam top having an upper surface and a lower surface, the lower surface disposed on the base;
at least one strap attached to the pad assembly;
wherein the pad assembly is configured to prevent bunching when lifting or repositioning the patient during surgical table positioning changes required during surgery, the reinforced pad assembly configured for movement in multiple directions during surgery.

2. The apparatus of claim 1, wherein the foam top comprises a pneumatic foam.

3. The apparatus of claim 1, wherein the base comprises a plurality of layers of a nonwoven material.

4. The apparatus of claim 3, further comprising a reinforcing sheet disposed between two of the layers of the base.

5. The apparatus of claim 4, wherein the reinforcing sheet comprises a condensed foam or a biodegradable cardboard.

6. The apparatus of claim 1, further comprising a post overlay disposed on the upper surface of the foam top.

7. The apparatus of claim 6, wherein the post overlay has at least one concave side wall.

8. The apparatus of claim 6, where the front wall of the post overlay is concave.

9. The apparatus of claim 7, wherein the bottom edge of the side wall is longer than the top edge of the side wall.

10. The apparatus of claim 9, wherein the front of the side wall curves upward from the bottom end to the top end.

11. The apparatus of claim 6, wherein the post overlay has a front wall that is concave and has a reduced width in the middle due to concave side walls.

12. The apparatus of claim 6, wherein the post overlay comprises a polyurethane foam.

13. The apparatus of claim 12, wherein the foam comprises a polyurethane foam having 1.8-6 PCF density with a 24-45 ILD (indentation load deflection).

14. The apparatus of claim 6, wherein the post overlay has a bore defined therein, the bore configured to receive a post mounted on an orthopedic table.

15. The apparatus of claim 1, wherein the strap further comprises hook and loop fasteners.

16. The apparatus of claim 1, wherein the strap is configured to wrap around a bed rail.

17. The apparatus of claim 1, wherein the strap is configured to extend across a narrow end of an anterior hip table.

18. A post overlay configured to mount over a post on a surgical table, the post overlay comprising:
a body bordered at least in part by a front wall, and a pair of side walls, the body having a bore defined therein configured to receive the post;
the side walls having a concave surface; and,
the front wall having a concave surface.

19. An apparatus for positioning a patient on a surgical table, the apparatus comprising:
a base having a top surface, the base having a plurality of handles attached thereto;
a foam top fixedly mounted to the top surface of the base to form a pad assembly, the pneumatic foam top having an upper surface and a lower surface, the lower surface disposed on the base;
at least one strap attached to the pad assembly;
a post overlay operatively associated with the upper surface of the foam top, the post overlay having concave side walls and a concave front wall facing the genital area of a patient.
wherein the pad assembly is configured to prevent bunching when lifting or repositioning the patient during surgical table positioning changes required during surgery, the reinforced pad assembly configured for movement in multiple directions during surgery;
wherein the foam top comprises a pneumatic foam.
